(19) United States
(12) Patent Application Publication
(10) Pub. No.: US 2006/0075917 A1
(43) Pub. Date: Apr. 13, 2006

(54) Smooth finish UV ink system and method

(76) Inventor: Paul A. Edwards, Ypsilanti, MI (US)

Correspondence Address: HARNESS, DICKEY & PIERCE, P.L.C., P.O. BOX 828, BLOOMFIELD HILLS, MI, 48303, US

(21) Appl. No.: 10/961,543

(22) Filed: Oct. 8, 2004

(51) Int. Cl. B41F 33/00

(52) U.S. Cl. 101/483

(57) ABSTRACT

A printing method includes steps of applying an ink-receptive coating to a substrate; printing an actinic radiation-curable ink jet ink over the coating; and curing the printed ink jet ink. An article printed by the method has a ink-receptive coating layer with a cured print. An apparatus for carrying out the method includes a coating station at which the ink-receptive coating is applied to a substrate, an ink jet printhead at which the energy-curable ink jet ink is applied, and a source of actinic radiation for curing the applied ink. The ink may be applied in sufficient amount to achieve a color density comparable to that obtained using other printing processes such as flexographic or gravure printing processes. The ink-receptive coating layer may be of a thickness sufficient to provide improve surface smoothness and/or reduced drop spread relative to an uncoated substrate.

### FIELD OF THE INVENTION

The invention relates to UV curing ink jet printing systems and methods.

### BACKGROUND OF THE INVENTION

Inks that cure on exposure to actinic radiation, such as ultraviolet (UV) light or electron beams, have been used in many applications. Gravure, flexographic, and ink jet inks that cure by actinic radiation are all known. Ink jet inks must have a very low viscosity, typically less than about 20 centipoise at the jetting temperature. One way to achieve this low viscosity is by including a substantial amount of organic liquids. In general, ink containing a substantial amount of organic liquids would produce undesirable emissions during the printing process. Such emissions are substantially avoided, however, with energy curable inks. Energy-curable inks use low viscosity reactive materials to attain the desired viscosity and generally have little or no volatile emissions. The reactive materials are exposed to actinic radiation after printing to cure them, as with UV-curable gravure inks, flexographic inks, and so on.

Inks incorporate a colorant, such as pigment. One difference between ink jet inks and other inks (such as flexo and gravure) that stems from their necessary low viscosity is that they must be formulated with relatively little pigment, since increasing pigment levels also increases ink viscosity. Hence, one must apply a much greater volume of ink jet ink than the volume of gravure ink, flexographic ink, etc. to achieve an equivalent color density. Apart from any issues of handling the ink or achieving through-cure is an issue of the higher volume of ink leaving the surface with a rougher texture that one is accustomed to obtain from the more conventional flexographic and gravure printing processes. FIG. 1 illustrates the build up of ink when layers of radiation-curable ink jet inks are applied to a smooth substrate 4 with each applied layer being cured before application of subsequent layers. Segment 1 shows a single, cured layer of ink; segment 2 shows a second, cured layer of ink over the first; and segment 3 show a third, cured layer of ink applied over the second. The difference in height of the drops across the printed area of the substrate results in uneven specular reflection of light and visual roughness. FIG. 2 illustrates the case where the succeeding radiation-curable ink jet ink layers are applied wet-on-wet to substrate 4, and the ink is cured only after all of the layers have been applied. The ink drops applied in segments 5 and 6 now have a longer time to flow out and together, resulting in a smoother print. The problem in this case is that flow of the drops also means loss of definition in the print. Thus, the print is smoother, but not as sharp.

It would be desirable to be able to obtain prints with a smoother, more conventional appearance using radiation-curing ink jet inks. The ease and flexibility of ink jet printing (no set up, easily varies print) offer advantages over conventional printing systems, but it is desirable to have prints that are as smooth and even as those that may be obtained with conventional printing systems.

Ink jet inks have been printed in wide format on vinyl films, rigid panels, and so on. Surface roughness causes a difference in gloss and reflective properties with change in angle, as well as a different feel to the print. The applied ink has been allowed to sit on the substrate longer before curing to enhance drop spread and, consequently, improve surface smoothness. Increasing drop spread, however, reduces print definition and increases variation between different substrates because of variation in rate of drop spread on the different substrates. Further, waiting for drop spread before cure makes the process more time-consuming and less efficient.

### SUMMARY OF THE INVENTION

The present invention provides a printing method, an article printed by the method, and a printing apparatus for carrying out the method, the method including steps of applying an ink-receptive coating to a substrate; printing an actinic radiation-curable ink jet ink over the coating; and curing the printed ink jet ink. The article printed by the method has a ink-receptive coating layer with a cured print. The apparatus for carrying out the method includes a coating station at which the ink-receptive coating is applied to a substrate, an ink jet printhead at which the energy-curable ink jet ink is applied, and a source of actinic radiation for curing the applied ink. The ink may be applied in sufficient amount to achieve a color density comparable to that obtained using other printing processes such as flexographic or gravure printing processes. The ink-receptive coating layer may be of a thickness sufficient to provide improve surface smoothness and/or reduced drop spread relative to an uncoated substrate.

The invention provides a method of ink jet printing a radiation-curable ink jet ink with excellent color density, surface smoothness, and print definition. The prints look more even and more like prints created by a conventional process such as gravure printing. There is also less variability from substrate to substrate.

“Actinic radiation-curable” inks and “energy-curable” inks are used interchangeably herein. Both include “UV-curable” inks, and when “UV-curable inks” is used, it does not limit the invention to only those energy curable inks curable by UV light (unless explicitly so limited by attendant description), but rather serves as an illustrative embodiment of the more general class of energy curable inks. “A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates a possible variation of up to 5% in the value.

### BRIEF DESCRIPTION OF THE DRAWINGS

The present invention will become more fully understood from the detailed description and the accompanying drawings, wherein:

FIG. 1 depicts a prior art application of radiation-curable ink jet ink to a substrate in layers in which each applied layer is cured before application of subsequent layers;

FIG. 2 depicts a prior art application of radiation-curable ink jet ink to a substrate in layers without curing between application of layers;

FIG. 3 depicts application of radiation-curable ink jet ink according to the invention;

FIG. 4 depicts a web printing arrangement for sequential application to the web of a coating, radiation-curable ink jet ink, and a clear varnish;

FIG. 5 depicts a printing arrangement for sequential application with a sheetfed press of a coating and ink jet application of both radiation-curable ink jet ink and radiation-curable clear varnish.

### DETAILED DESCRIPTION OF THE PREFERRED EMBODIMENTS

The following description of the preferred embodiment(s) is merely exemplary in nature and is in no way intended to limit the invention, its application, or uses.

The inventive system and method provide a means of printing an energy-curable ink with a desirable color density onto nonabsorbent and semi-nonabsorbent substrates. In a first step, a coating receptive to the energy-curable ink is applied to a substrate. The coating may be applied, for example, using flexography gravure coating, bead coating, sloth coating, reverse gravure coating, spray coating, or other known coating methods.

The ink-receptive coating can be applied over nonporous substrates like metal sheets that may then be formed into cans, plastic, glossy-finished paper or paperboard. Examples of nonabsorbent or semi-nonabsorbent substrates include, without limitation, high gloss paper, satin paper, coated papers, or paperboard; plastic (e.g., polyethylene, polypropylene, or polyester), which may be supplied as webs, rolls, or sheets; plastic and metal packaging materials, vinyl sheets, panels, polystyrene sheets, steel, aluminum, wood, and other substrates.

The ink-receptive coating includes a microporous, material and a coating vehicle that are receptive to the energy-curable ink. Examples of absorbent, microporous materials include, without limitation, highly porous silica, porous inorganic oxides, particularly silica gels such as silica hydrogels, aerogels, xerogels, cogels, and other inorganic oxides such as alumina, silica/alumina, and titania. In general, inorganic oxides having pore volumes of 0.6 cc/g or more are preferred, particularly those having pore volumes of 0.6 to 3.00 cc/g are suitable. Also in general, the average particle size should be in the range of 1 to 20 microns, preferably about 3 to about 12 microns, particularly preferably about 5 to about 8 microns.

Examples of coating vehicles that may be used include polymers or resin, such as, without limitation, water soluble or dispersible film-forming polymers and/or latex polymers such as poly(vinyl alcohol), poly(vinyl acetate), copolymers of vinyl acetate, hydroxyethyl cellulose, methyl cellulose, carboxy methyl cellulose, starch, gum arabic, polyethylene glycol poly(vinyl pyrrolidone), polyacrylamide, polypropylene glycol, polyketone resins, and combinations of these, which may be combined with water and/or organic solvents, The coating may also have a UV-cured binder, typically in low concentration and included to help hold the particles together. The coating vehicle may be selected or modified to obtain desired coating characteristics, such as flexibility and durability. For example, a UV-cured binder can be employed for increased durability, while a flexible, solvent-based polymer system, such as polyurethane, can be employed for flexibility. In other examples, a polyketone may be used for good adhesion to many substrates; a crosslinked, waterbome polymer may be used for increased water resistance. The ink-receptive coating may also be curable for improved properties such as water and solvent resistance. The coating vehicles including polymers or resins may be thermoset or curable, for examples with heat, by further including crosslinkers and, optionally, catalysts. Examples of suitable crosslinkers are, without limitation, melamine formaldehyde resins, urea formaldehyde resins, polyepoxide resins, and polyisocyanate curing agents. Examples of suitable catalysts are, without limitation, amine-blocked sulfonic acid catalysts such as blocked p-toluene sulfonic acids, tin catalysts such as dibutyl tin dilaurate and dibutyl tin oxide, and tertiary amines, depending upon the particular cure reaction mechanism selected.

The ink-receptive coating vehicle may also be energy-curable, or curable by exposure to actinic radiation. Energy-curable coating vehicles may include mixtures of ethylenically unsaturated monomers and oligomers, which may be monofunctional and polyfunctional, and photoinitiators. An energy-curable coating may alternatively or additionally include cationically curing compounds. Photoinitator remaining in the coating should also be beneficial in increasing the rate and/or extent of cure of the ink. Photoinitiator may also be included in an ink-receptive coating that is not curable by actinic radiation for the benefit it may provide for curing the actinic radiation-curable ink.

The porous, absorbent particles may be included at amounts of 20 to 80 percent by weight, preferably at least 40 percent by weight, of the nonvolatile components of the ink-receptive coating composition. The ink is absorbed into the porous particles and may be absorbed by the coating matrix, also.

In various embodiments, ink-receptive coating compositions may include other components such as optical brighteners, crosslinking agents such as driers for the polymer or resin, dispersants, lubricants, preservatives, photoinitiators, and so on.

The applied, ink-receptive coating layer is dried and/or cured. The coating layer should be thick enough to absorb the ink jet ink printing onto it sufficiently to produce a smooth, printed surface on the substrate. The coating layer may also serve to provide a desired amount of drop spread in the printed ink jet ink, resulting in good print definition. The receptive capabilities of the coating that allow the ink to form a fairly smooth print and/or print of good definition should be balanced to guard against the ink migrating so deeply into the ink-receptive coating layer that color density or cure is compromised. In general, the coating composition is applied at rates of about 2 to about 30 g/m², preferably from about 10 to about 20 g/m².

If the ink receptive coating is curable on exposure to actinic radiation, in which case the coating station may include a source of actinic radiation to which the coating is exposed after application to the substrate. In various embodiments, the coating station may include a heater for at least partially drying the applied coating. The applied coating layer can be dried, for example, at room temperature, by hot air drying, heat surface-contact drying, or heat radiation drying. Curable applied coating layers can be cured under appropriate conditions, such as thermally or by exposure to actinic radiation, as mentioned.

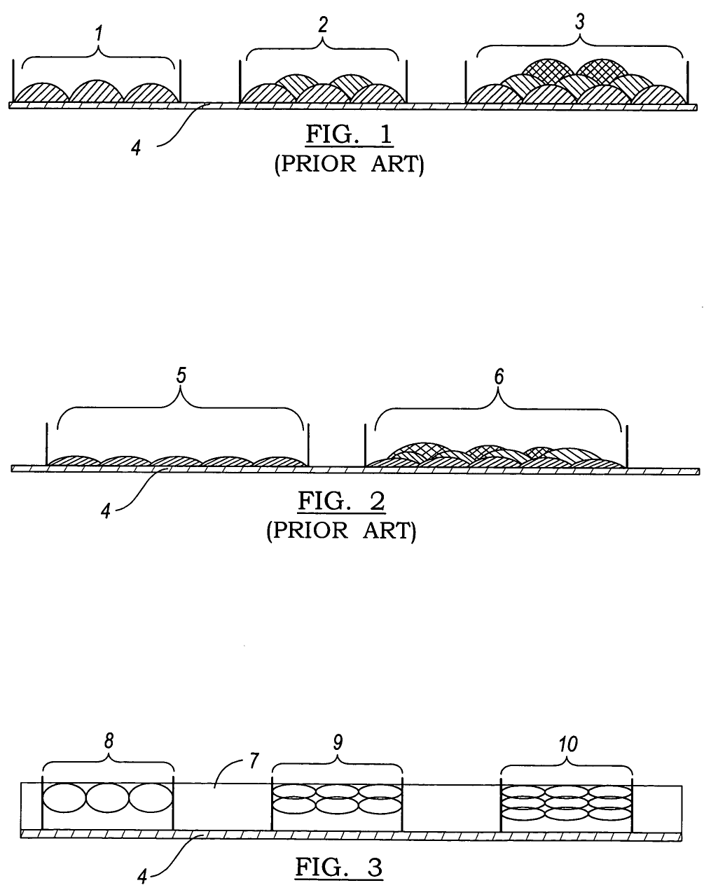

Ink jet ink is applied onto the ink-receptive coating from one or more ink jet printheads. The ink jet ink is curable by exposure to actinic radiation. Referring now to FIG. 3, coating layer 7 on substrate 4 absorbs the ink jet ink drops as they are applied so that the surface of the print remains smooth. Thus, in segment 8, a first layer of radiation-curable ink jet ink is absorbed into the coating layer, in segment 9 a second layer of radiation-curable ink jet ink is absorbed into the coating layer, and in segment 10, a third layer of radiation-curable ink jet ink is absorbed into the coating layer. The applied radiation-curable ink jet ink may be cured by exposure to actinic radiation, such as ultraviolet light.

The ink jet ink includes one or more radiation-curable compounds. Suitable examples of radiation-curable compounds include, without limitation, ethylenically unsaturated monomers and oligomers, which may be monofunctional or polyfunctional, and epoxy-functional monomers and oligomers, which may also be monofunctional or polyfunctional, such as alkyl acrylate, alkylene diacrylates, polyurethane acrylate oligomers, polyester acrylate oligomers, epoxy acrylates, bisphenol polyepoxide esters and ethers, and so on. The ink jet ink compositions may further include a photoinitiator or combination of photoinitiators one or more colorants (dyes and/or pigments), surfactants, and other desired components.

After printing, the ink is exposed to actinic radiation to cure the ink in the coating matrix by free radical or cationic cure mechanism. Full-color images may be printed using a printing process with four or more colors of ink. When more than one color is laid down in an area, the ink droplets of the color first printed may be at least partially cured before the next color is applied, and so. Thus, a four-color black area can be physically and visually very different from an area that receives only one layer and color of the ink jet ink (such as a yellow area). A clear (unpigmented) radiation-curable ink jet ink can be printed in areas have little or no colored ink jet ink for a smoother, glossier surface.

The printed substrate may be finished with a clear, protective coating, such as a UV curing varnish, at a further coating station to protect the ink-receptive coating layer from absorbing other materials. The protective coating may be cured after being applied over the cured ink jet ink. In various embodiments, clear UV varnish may be printed by ink jet printing in those areas in which no color has been printed in order to give the image a smooth, consistent finish.

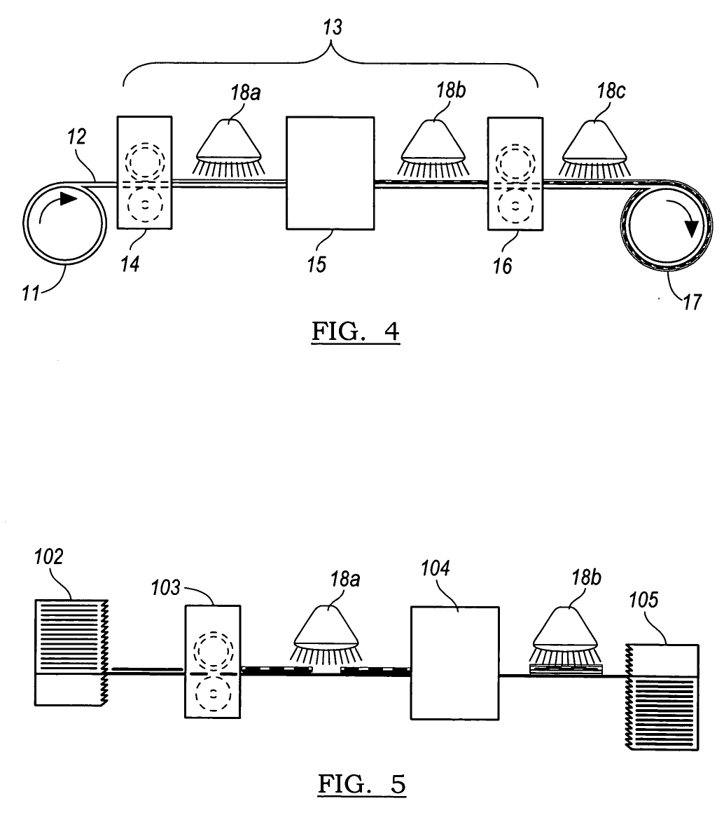

FIG. 4 illustrates a web printing arrangement according to the invention for sequential application to the web of a coating, radiation-curable ink jet ink, and a clear varnish. Substrate 12, which may be absorbent or nonabsorbent, is unwound from roll 11 and passes through coating station 14, where it receives a layer of ink-receptive coating in the area(s) to be printed. Coating station 14 may be, for example, a flexographic, gravure, bead, or slot coater. The coating layer is then dried and/or cured by dryer 18, which may be a heat source or actinic radiation source. The coated substrate 12 then passes through ink jet printer 15, which may apply four to eight colors of radiation-curable ink jet ink for full-color printing on coated substrate 12. The printed ink is then cured by exposure to actinic radiation source 18b. Finally, web substrate 12 passes through coating station 16 where a clear varnish is applied to at least the areas of the substrate coated with the ink-receptive coating. This seals the coating, preventing further absorption of materials. The varnish is dried or cured by dryer 18c and the finished, printed substrate 12 is taken up on roll 17.

FIG. 5 depicts a printing arrangement for sequential application with a sheetfed press of a coating and ink jet application of both radiation-curable ink jet ink and radiation-curable clear varnish. A sheet is taken from stack 102 and coated in the area(s) to be printed with an ink-receptive coating in coating station 103. The coating is then dried and/or cured by dryer 18a. Next, the coated sheet passes through the ink jet print area 104, where separate ink jet heads apply a desired number of radiation-curable ink jet inks in the coated area(s) on the substrate. In this case, a last ink jet head applies a clear, radiation-curable ink jet varnish over the coated area(s). The applied ink jet ink(s) and varnish are then cured by exposure to actinic radiation from source 18b, and the finished sheet is received on stack 105.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A printing method, comprising steps of
(a) applying an ink-receptive coating to a substrate;
(b) printing an actinic radiation-curable ink jet ink over the coating; and
(c) curing the printed ink jet ink.

2. A printing method according to claim 1, wherein the ink jet ink is printed in sufficient amount to achieve a color density comparable to that obtained using a flexographic or a gravure printing process.

3. A printing method according to claim 1, wherein the ink-receptive coating has a thickness sufficient to provide improve surface smoothness or reduced drop spread, or both, relative to an uncoated substrate.

4. A printing method according to claim 1, wherein the substrate is nonabsorbent or semi-nonabsorbent.

5. A printing method according to claim 1, wherein the ink-receptive coating comprises a member selected from the group consisting of highly porous silica, porous inorganic oxides, silica gels,, and combinations thereof.

6. A printing method according to claim 1, wherein the ink-receptive coating comprises an inorganic oxide having a pore volume of at least about 0.6 cc/g.

7. A printing method according to claim 1, wherein the ink-receptive coating comprises a microporous material having an average particle size in the range of 1 to 20 microns.

8. A printing method according to claim 1, wherein the ink-receptive coating is cured by exposure to actinic radiation.

9. A printing method according to claim 8, wherein photoinitiator in the coating increases the rate of cure or extent of cure, or both, of the ink

10. A printing method according to claim 1, wherein the ink-receptive coating is thermoset.

11. A printing method according to claim 1, wherein the ink-receptive coating vehicle provides a desired property selected from the group consisting of flexibility, durability, adhesion to the substrate, water resistance, solvent resistance and combinations thereof.

12. A printing method according to claim 1, comprising a further step of:
(d) applying over the cured ink jet ink a protective coating.

13. A printing method according to claim 12, wherein the protective coating is cured after being applied.

14. A printing apparatus, comprising
a coating station at which an ink-receptive coating is applied to a substrate,
an ink jet printhead that applies an energy-curable ink jet ink on the coating, and
a source of actinic radiation for curing the applied ink.

15. An apparatus according to claim 14, wherein the coating station includes a source of actinic radiation for curing the coating.

16. An apparatus according to claim 14, wherein the coating station includes a heater for at least partially drying the coating.

17. An apparatus according to claim 14, comprising more than one ink jet printhead.

18. An apparatus according to claim 17, wherein one printhead applies a clear, radiation-curable ink jet ink.

19. An apparatus according to claim 14, further comprising a coating station that applies a clear, protective coating over applied the ink jet ink.

20. An article printed by the method of claim 1.
